(19) United States
(12) Patent Application Publication
(10) Pub. No.: US 2006/0177260 A1
(43) Pub. Date: Aug. 10, 2006

(54) Retractable raiser

(75) Inventor: Hsueh-Sen Liao, Hsin-Chu Hsien (TW)

Correspondence Address: TROXELL LAW OFFICE PLLC, SUITE 1404, 5205 LEESBURG PIKE, FALLS CHURCH, VA, 22041, US

(73) Assignee: Hsin Lung Accessories Co., Ltd.

(21) Appl. No.: 11/236,593

(22) Filed: Sep. 28, 2005

(30) Foreign Application Priority Data
Feb. 5, 2005 (TW) 094202384

(51) Int. Cl. F16B 7/10

(52) U.S. Cl. 403/109.1

(57) ABSTRACT

A retractable raiser related to a tube fixed to head tube of fork to retract therein; a clamping member in the moving route of the raised tube to secure it; a bead bowl set between the head tube and raised tube; a bracket above a locking member; the contact between the locking member and the bracket being threaded; and multiple retainers below the bracket to suppress the bead bowl set as the bracket pushes against the bracket for the bead bowl set to pack against the top of the stem of the frame.

### BACKGROUND OF THE INVENTION

(a) Field of the Invention

The present invention is related to a retractable raiser, and more particularly to a coupling structure between fork and handle of a bike that allows adjustment of the height of the handle as required.

(b) Description of the Prior Art:

Whereas the front wheel of a bike is essentially provided for controlling the balance and turning direction of the bike, the front wheel is connected to the handle by means of a fork. When the handle takes a turn, the front wheel also takes the turn as directed by the handle while maintaining the balance of the bike. Therefore, the fork and the handle are coupled to each other at where in the middle of the shoulder of the fork and the handle so to allow consistent response of the front wheel to take a right or a left turn in preventing control difficulties.

As illustrated in FIG. 1 of the accompany drawings for a sectional view of a handle raiser of the prior art, a raised tube 31 is disposed to a head tube 10 of a fork to be inserted with a stem of the handle. The raised tube 31 permits longitudinal movement in the head tube 10. A clamping member 33′ is disposed in the gravel of the raised tube 31 so to secure the head tube 31 in position. The clamping member 33′ relates to a bracket structure disposed at its center an insertion hole 331′. Two pairs of clamping ears 332′ extend from one side of the clamping member 33′. A gap 333′ extend from where between both pairs of clamping ears 332′ to the insertion hole 331′, and a screw 41 penetrates through the other pair of clamping ear 332′. A bead bowl set 50 is disposed between the head tube 1− and a stem 12. A compression ring 70 disposed below the clamping member 33′ enters into the clamping member 33′ and is provided with a thread 44 at where it contacts the clamping member 33′. Furthermore, both of the clamping member 33′ and the compression ring 70 are first inserted into the raised tube 31. A positioning member 42 is locked to one side of the raised tube 31 to prevent the raised tube 31 from escaping out of the claming member 33′ thus to make the raised tube 31, the clamping member 33′, and compression ring 70 an integral part.

When assembled, an opening 11 is provided at the top of the head tube 10 to place the raised tube 31, the clamping member 33′ and the compression ring 70 at the top of the head tube 10. While the clamping member 33′ and the compression ring 70 are inserted to the head tube 10, the raised tube 31 is permitted to longitudinally move in the head tube 10. The clamping member 33′ is tightened up by the locking force from the screw 41 to clamp the head tube 10 so to pack the compression ring 70 to push against the bead bowl set 50 at the top of the stem 12. The raised tube 31 is adjusted for a proper height. A fast connector 334′ is provided to further hold the clamping member 33′ thus to secure the raised tube 31 in the clamping member 33′ to achieve the purpose of adjusting the height of the handle. However, the compression ring 70 is prevented from a smooth push against the bead bowl set, and it takes a special tool to achieve the packing purpose. Furthermore, the top of the head tube 10 must be broken to provide the opening 11 not only prevents an easier assembly but also compromises the structure of the bike.

### SUMMARY OF THE INVENTION

The primary purpose of the present invention is to provide a retractable raiser for adjusting the height of a handle of a bike without requiring the special tool to pack the bead bowl set against the top of the head tube of the frame and damaging the integral structure of the head tube.

To achieve the purpose, a raised tube is provided to a head tube of the fork to receive the insertion of a stem of the handle; the raised tube is fixed to the upper end of the head tube by means of a locking member and permitted to move up and down inside the head tube; a clamping member is disposed in the travel of the raised tube to secure the raised tube; a bead bowl set is disposed between the head tube and the stem of the frame; a bracket is disposed on the upper side of the locking member and is threaded at where contacts the locking member; multiple retainers are disposed below the bracket so to press the bead bowl set against the top of the stem when the bracket is pushing toward the bead bowl set.

### BRIEF DESCRIPTION OF THE DRAWINGS

FIG. 1 is a sectional view of a structure of a raised tube of the prior art attached to a handle of a bike.

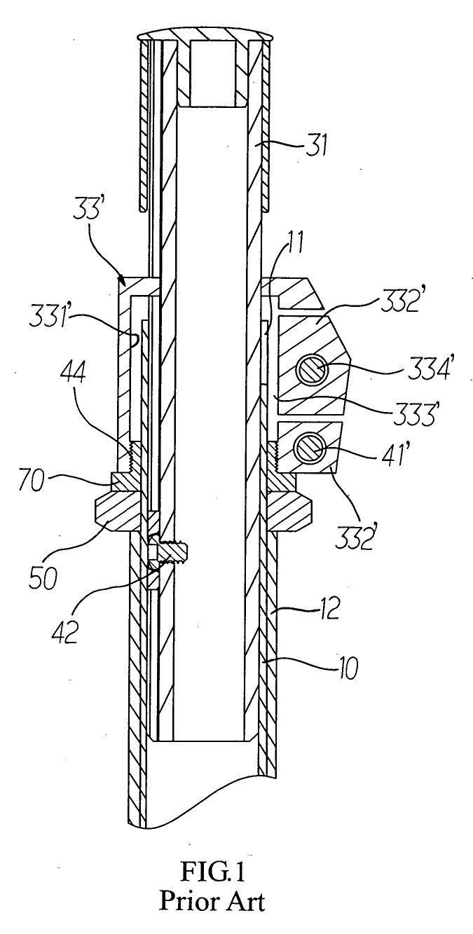

FIG. 2 is a perspective view of the present invention.

FIG. 3 is an exploded view of the present invention.

FIG. 4 is a schematic view showing a structure of the present invention.

FIG. 5 is a schematic view showing the adjustment of the handle by means of the present invention.

### DETAILED DESCRIPTION OF THE PREFERRED EMBODIMENTS

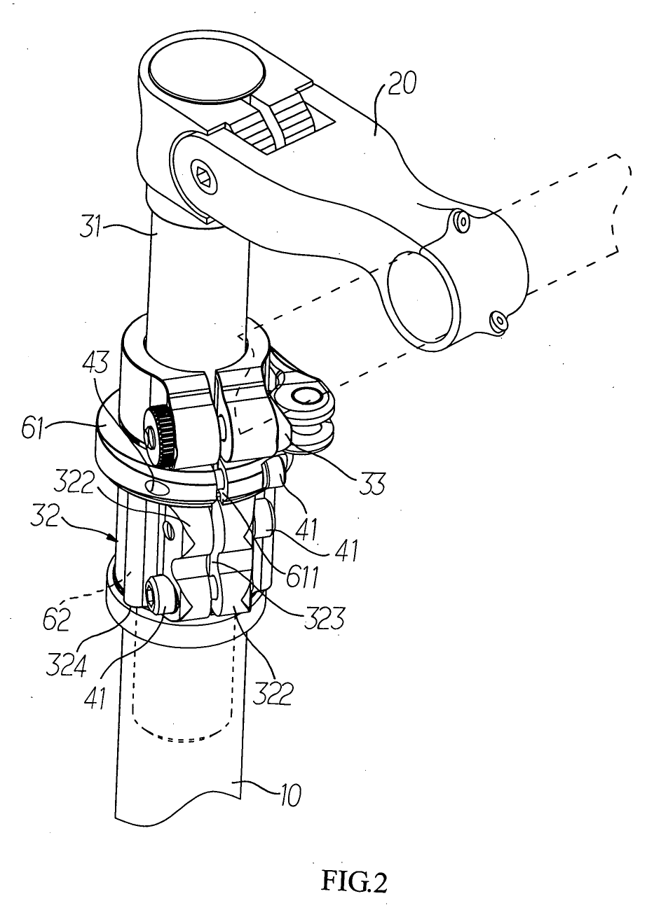

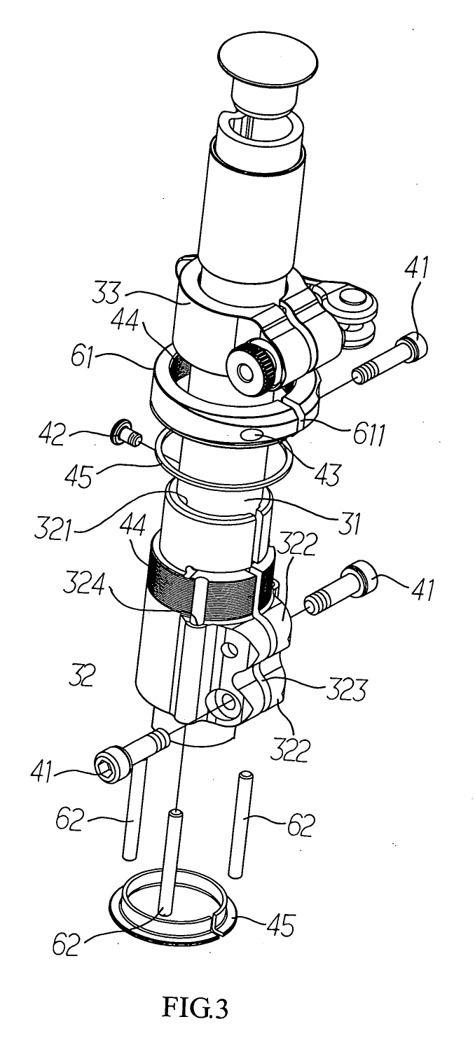

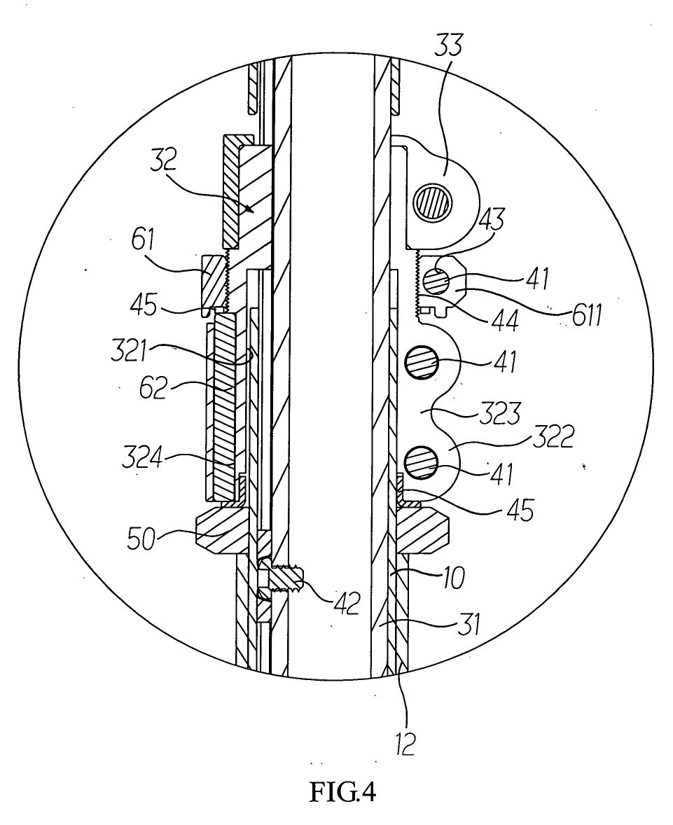

Referring to FIGS. 2, 3, and 4, a retractable raiser of a preferred embodiment of the present invention to adjust the height of a handle of a bike is essentially comprised of a raised tube 31 disposed on a head tube 10 of a fork to receive insertion by a stem 20 of the handle. The raised tube is fixed to the upper end of the head tube 10 by means of a locking member. The locking member 32 related to a bracket structure disposed at its center an insertion hole 321. A pair of clamping ears 322 extends from one side of the locking member 32, and a gap 323 extends between the pair of the clamping ears 322 to reach the insertion hole 321. A screw 41 penetrates through both clamping ears 322. The raised tube 31 is permitted to move up and down inside the head tube 10, and a clamping member 33 is disposed in the traveling route of the raised tube 10. The clamping member 33 is disposed outside the locking member. In the preferred embodiment, the clamping member 33 is made in the form of a fast connector to secure the raised tube 31. Furthermore, both of the locking member 32 and the clamping member 33 are first inserted into the raised tube 31. A positioning member 42 is locked to one side of the raised tube 31 to keep the raised tube 31 secured inside the locking member 32 and the clamping member 33. Accordingly, the raised tube 31, the locking member 32 and the clamping member 33 become an integrated part.

A bead bowl set 50 is disposed between the head tube 10 and a stem 12 of the frame of the bike. A bracket 61 is disposed above the locking member 32 and a longitudinal groove 611 is disposed on the bracket 61. Two screw holes 43 are respectively disposed on both sides of the bracket in relation to the groove 611 to be fastened with a screw 41. The bracket 61 is threaded at where it contacts the locking member 32, and multiple slots 324 are disposed on the outer perimeter of the locking member 32 to respectively accommodate multiple retainers 62 so that each retainer 61 is disposed at where between the bracket 61 and the bead bowl set 50. A press ring 45 is further disposed between the bead bowl set 50 and the bracket 61.

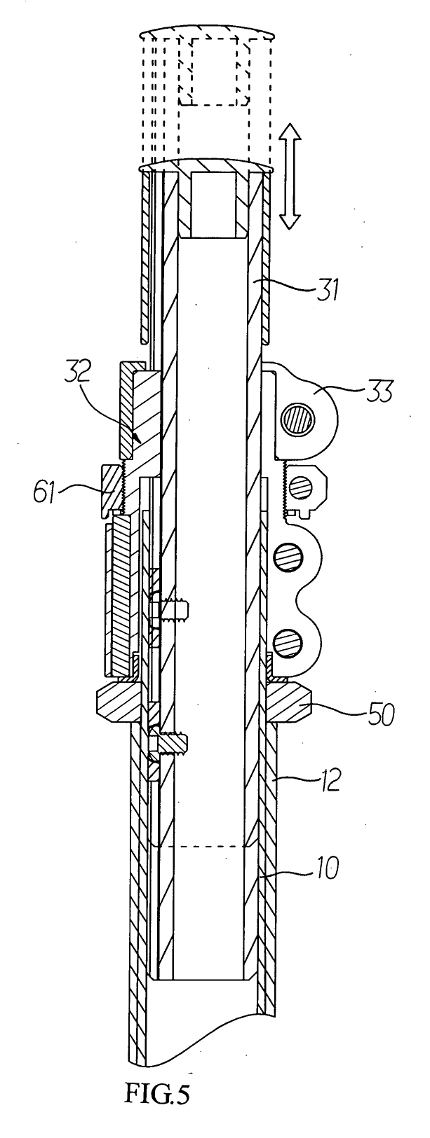

When assembled, the raised tube 31, the locking member 32 and the clamping member 33 are placed on the upper end of the stem 12. Both of the locking member 32 and the clamping member 33 are inserted into the head tube 10 to permit the raised tube 31 to move up and down inside the head tube 10. The locking member 32 is tightened up to hold the head tube by means of the locking force from the screw 41 for the bracket 61 to push in the direction of the bead bowl 50. Those multiple retainers 62 compress the bead bowl set 50 to pack the bead bowl set 50 against the top of the stem 12 of the frame of the bike. The bracket 61 is tightened up by the locking force from the screw 41 to hold onto the locking member for adjusting the raised tube 31 to its proper height. As illustrated in FIG. 5, the clamping member 33 secures the locking member 32 to further secure the raised tube 31 inside the locking member to conclude an easy adjustment of the height of the handle.

The prevent invention provides an improved structure of a retractable raiser to adjust the height of a handle of a bike, and the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

I claim,

1. A retractable raiser for a handle of a bike that couples a head tube of a fork and the middle position of a handle of the bike is comprised of a raised tube to receive insertion by the head tube of the handle; the raised tube being fixed to the upper end of the head tube by means of a locking member; the raised tube being permitted to move up and down inside the head tube; a clamping member being disposed in the traveling route of the raised tube to fix the raised tube; a bead bowl unit being disposed between the head tube and a stem of the frame of the bike; a bracket being disposed on the upper side of the locking member; the end of the bracket being threaded at where it contacts the locking member; multiple retainers being disposed below the bracket; those multiple retainers pressing against the bead bowl set as the bracket pushes toward the bead bowl unit; and the those multiple retainers packing the bead bowl set against the top of the stem of the frame.

2. The retractable raiser of claim 1, wherein the locking member relates to a bracket structure having disposed at its center an insertion hole; a pair of clamping ears extending from one side of the locking member; a gap extending from where between the pair of the clamping ears to reach the insertion hole; a screw penetrating through both clamping ears; and the head tube being clamped by the locking member with the locking force from the screw.

3. The retractable raiser of claim 1, wherein multiple slots are disposed on the external perimeter of the locking member, and each retainer is secured at where between the bracket and the bead bowl set.

4. The retractable raiser of claim 1, wherein a press ring is further disposed at where between each retainer and the bead bow set.

5. The retractable raiser of claim 1, wherein a compression-ring is further disposed at where between each retainer and the bracket.

6. The retractable raiser of claim 1, wherein a longitudinal groove is disposed on the bracket and two screw holes are respectively disposed on both sides of the bracket in relation to the groove; and a screw penetrates through both screw holes to tightly secure the bracket to the locking member.

7. The retractable raiser of claim 1, wherein the clamping member is made in the form of a fast connector.

8. The retractable raiser of claim 1, wherein the clamping member is disposed outside the locking member.

9. The retractable raiser of claim 1, wherein both of the clamping member and the locking member are first inserted into the raised tube; and a retainer is locked to one side of the raised tube.
